(19) United States
(12) Patent Application Publication
(10) Pub. No.: US 2018/0178561 A1
(43) Pub. Date: Jun. 28, 2018

(54) PRINTING SYSTEM AND EXTENSION UNIT

(71) Applicant: SEIKO EPSON CORPORATION, Tokyo (JP)

(72) Inventors: Kazuhiro NISHIYAMA, Shiojiri (JP); Soshi OKAWA, Shiojiri (JP); Nobutaka SUZUKI, Shiojiri (JP)

(21) Appl. No.: 15/847,020

(22) Filed: Dec. 19, 2017

(30) Foreign Application Priority Data
Dec. 27, 2016 (JP) 2016-254249
Sep. 28, 2017 (JP) 2017-188287

(51) Int. Cl. B41J 13/10; B41J 2/175; B41J 13/02

(52) U.S. Cl. CPC B41J 13/103; B41J 13/02; B41J 2/175

(57) ABSTRACT

The invention provides a printing system and an extension unit that can transport media of any specified sizes appropriately.

### BACKGROUND

### 1. Technical Field

The present invention relates to an extension unit that is addable to a printing apparatus such as an ink jet printer and further relates to a printing system that includes a printing apparatus and an extension unit.

### 2. Related Art

Ink jet printers are one example of printing apparatuses provided in printing systems. An ink jet printer discharges liquid such as ink from its head onto a paper sheet or other medium, thereby printing information thereon. As an example, JP-A-2015-96302 discloses an ink jet printer that includes: a supply cassette (medium storage unit) that accommodates paper sheets to be supplied to the head; and a liquid storage unit that contains ink to be supplied to the head.

When the above exemplary ink jet printer performs a print operation, a paper sheet is transported from the supply cassette to the head. In this case, the paper sheet passes behind the liquid storage unit, because the supply cassette is disposed below the liquid storage unit. So, the transport route of the paper sheet extends so as to avoid the liquid storage unit. As a result, the length of the transport route may increase, and transport members such as rollers may be arranged away from one another along this transport route. In which case, the transport members may fail to appropriately transport paper sheets along the transport route, depending on their sizes.

### SUMMARY

An advantage of some aspects of the invention is that a printing system and an extension unit can transport media of any specified sizes appropriately.

According to a first aspect of the invention, a printing system includes: a printing apparatus; an extension unit that accommodates media and is disposed below the printing apparatus; and a transport route along which the media are transported to a printing unit in the printing apparatus. The printing apparatus includes: the printing unit that prints information on the media by using a recording material; a first storage unit that accommodates the media; a second storage unit that accommodates an object related to the printing apparatus and is disposed below the first storage unit; and a first paper feed mechanism that feeds the media accommodated in the first storage unit to the transport route. The extension unit includes: a housing; a third storage unit that accommodates the media; a second paper feed mechanism that feeds the media accommodated in the third storage unit to the transport route; and a feed roller that transports the media fed by the second paper feed mechanism and is disposed in the transport route. The feed roller is disposed so as to overlap the second storage unit in a horizontal direction.

In this configuration, the feed roller in the extension unit is disposed so as to overlap the second storage unit in the printing apparatus in the horizontal direction. The feed roller thereby can be disposed near the printing apparatus. Therefore, in the transport route, the printing unit in the printing apparatus can be disposed near the feed roller in the extension unit. Consequently, the printing system can transport media of any specified sizes appropriately.

In the printing system, a liquid storage body that contains a liquid as the recording material or a container that accommodates the liquid storage body is preferably attachable to the second storage unit.

With this configuration, the second storage unit can be used efficiently as a space in which the liquid is stored as the recording material.

In the printing system, the second storage unit preferably includes a liquid supply route along which the liquid contained in the liquid storage body is supplied to the printing unit, and the liquid supply route is preferably provided so as to overlap the second paper feed mechanism in a vertical direction.

With this configuration, the printing system can supply the liquid appropriately to the printing unit through the liquid supply route despite its small footprint.

In the printing system, the second paper feed mechanism preferably includes at least one of a pickup roller, a retard roller, and a separation roller that feeds one by one the media in the extension unit.

With this configuration, the printing system can feed the media appropriately by using the second paper feed mechanism.

According to a second aspect of the invention, a printing system includes: a printing apparatus; an extension unit that accommodates media and is disposed below the printing apparatus; a transport route along which the media are transported to a printing unit in the printing apparatus; and a feed roller disposed in the transport route. The printing apparatus includes: the printing unit that prints information on the media by using a recording material; a first storage unit that accommodates the media; a first paper feed mechanism that feeds the media accommodated in the first storage unit to the transport route; an inversion roller disposed in the transport route and downstream of the first paper feed mechanism in a transport direction of the media; and a second storage unit disposed below the first storage unit. A liquid storage body that contains a liquid as the recording material or a container that accommodates the liquid storage body is attachable to the second storage unit. The extension unit includes: a third storage unit that accommodates the media and is disposed below the second storage unit, and a second paper feed mechanism that feeds the media accommodated in the third storage unit to the transport route. The feed roller is disposed so as to overlap the second storage unit in a horizontal direction and transports the media fed by the second paper feed mechanism to the inversion roller.

In this configuration, the feed roller in the extension unit is disposed so as to overlap the second storage unit in the printing apparatus in the horizontal direction. The feed roller thereby can be disposed near the printing apparatus. Therefore, in the transport route, the inversion roller in the printing apparatus can be disposed near the feed roller in the extension unit. Consequently, the printing system can transport media of any specified sizes appropriately.

In the printing system, the second storage unit preferably includes a liquid supply route along which the liquid contained in the liquid storage body is supplied to the printing unit, and the liquid supply route is preferably provided so as to overlap the second paper feed mechanism in a vertical direction.

In this configuration, the liquid is supplied from the liquid storage body to the printing unit through the liquid supply route. Thus, the printing system enables the printing unit to perform a print operation over a prolonged period.

In the printing system, the feed roller is preferably detachable from the printing system.

With this configuration, the feed roller can be easy to replace with another.

In the printing system, the second paper feed mechanism preferably includes at least one of a pickup roller, a retard roller, and a separation roller that feeds one by one the media in the extension unit.

With this configuration, the printing system can feed the media appropriately by using the second paper feed mechanism.

According to a third aspect of the invention, an extension unit to be added to a printing apparatus includes: a housing; a medium storage unit that accommodates media; a paper feed mechanism that feeds the media accommodated in the medium storage unit; and a feed roller that transports the media fed by the paper feed mechanism to the printing apparatus. The feed roller is disposed so as to overlap the printing apparatus in a horizontal direction when the extension unit is attached to a lower portion of the printing apparatus.

In this configuration, the feed roller in the extension unit is disposed so as to overlap the printing apparatus in a horizontal direction. Thus, when the extension unit is attached to the lower portion of the printing apparatus, the configuration disposes the feed roller nearer the printing apparatus than a configuration in which the feed roller is disposed so as not to overlap the printing apparatus in the horizontal direction, such as a configuration in which the feed roller is disposed below the printing apparatus. Consequently, the printing apparatus can transport media of any specified sizes appropriately.

In the extension unit, the housing preferably has a recess in its rear surface, and when a second extension unit is further disposed below the extension unit, the recess preferably accommodates a feed roller of the second extension unit.

With this configuration, when a second extension unit, which is another independent extension unit, is disposed below the above extension unit, the recess in the extension unit preferably accommodates a feed roller of the second extension unit. Consequently, the extension unit provides an improved appearance.

### BRIEF DESCRIPTION OF THE DRAWINGS

The invention will be described with reference to the accompanying drawings, wherein like numbers reference like elements.

FIG. 1 is a schematic front view of a printing system in an embodiment of the invention.

FIG. 2 is a perspective view of the printing system.

FIG. 3 is a cross-sectional view taken along an arrow III-III of FIG. 1.

FIG. 4 is a perspective view of the printing system and the cover that are separated from each other.

FIG. 5 is a perspective view of the extension unit.

FIG. 6 is a side view of the extension unit.

FIG. 7 is a perspective view of the printing system in which the printing apparatus and the extension unit are separated from each other.

FIG. 8 is a side view of a printing system in a modification.

FIG. 9 is a side view of a printing system in another modification.

FIG. 10 is a front view of a printing system in a still another modification, which differs from those illustrated in FIGS. 8 and 9.

FIG. 11 is a cross-sectional view taken along an arrow XI-XI of FIG. 10.

### DESCRIPTION OF EXEMPLARY EMBODIMENTS

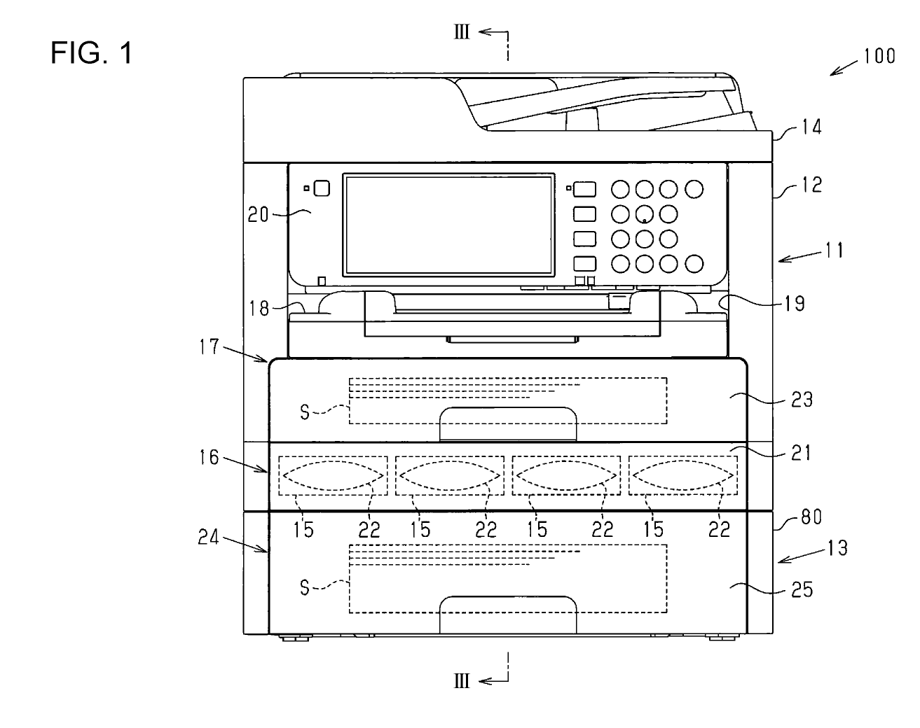

A description will be given below of a printing system in an embodiment of the invention and an extension unit provided in this printing system. As illustrated in FIG. 1, a printing system 100 includes a printing apparatus 11 and an extension unit 13 disposed under the printing apparatus 11. The printing apparatus 11 includes an apparatus main body 12 having a cuboid shape. The extension unit 13 is added to and disposed below the apparatus main body 12. In other words, the extension unit 13 is attached to a lower portion of the apparatus main body 12. The apparatus main body 12 allows a plurality of extension units 13 to be added thereto. In addition, the extension unit 13 is addable to not only the lower portion of the apparatus main body 12 but also a lower portion of another extension unit. In other words, if the extension unit 13 (first extension unit) is added to the apparatus main body 12, another extension unit (second extension unit) is addable to the lower portion of the first extension unit. The apparatus main body 12 includes a reading unit 14 on the top. This reading unit 14 can read images of letters, characters, and various pictures recorded on an original sheet.

The apparatus main body 12 further includes a mounting unit 16 and a medium holder (first storage unit) 17. The mounting unit 16 and the medium holder 17 are disposed in this order from the bottom to which the extension unit 13 is added. The mounting unit 16 permits containers 15 to be detachably attached thereto; the medium holder 17 can hold media S, such as paper sheets. The apparatus main body 12 further includes an ejection port 19 and an operating unit 20 on its front surface and above the medium holder 17. After the print operation, a medium S is ejected to an ejection tray 18 through the ejection port 19. The operating unit 20 is used for a user to operate the printing apparatus 11. Herein, the expression “the front surface of the apparatus main body 12” refers to a side surface of the apparatus main body 12 which has a predetermined height and width and is used to operate the printing apparatus 11.

The mounting unit 16 is covered with a front panel 21; the front panel 21 is pivotable and forms a portion of the front panel of the apparatus main body 12. The mounting unit 16 allows one or more (four in this embodiment) containers 15 to be attached thereto, and each container 15 allows a liquid storage body 22 to be detachably attached thereto. Each liquid storage body 22 contains a liquid, which is an example of a recording material that the printing apparatus 11 uses when printing information on the media S. The liquid storage bodies 22 contain different types of liquids, such as black, cyan, magenta, and yellow inks. Each container 15 is detachably attachable to the mounting unit 16 even if not holding the liquid storage body 22. Alternatively, the liquid storage bodies 22 may be attachable directly to the mounting unit 16, in which case the containers 15 are not necessary. In this embodiment, a direction in which the containers 15 are attached to the mounting unit 16 is substantially perpendicular to a width direction of the printing apparatus 11 and corresponds to a depth direction of the printing apparatus 11.

The medium holder 17 has a medium holding body 23 that can accommodate a pile of media S. The medium holding body 23 is detachably attached to the front surface of the apparatus main body 12. In short, the medium holder 17 holds the media S through the medium holding body 23. Alternatively, the medium holder 17 may hold the medium S directly, in which case the medium holding body 23 is not necessary.

The inner space (second mounting unit 16) of the printing apparatus 11 does not necessarily have to store the mounting unit 16. Instead, this space may store accessories such as auxiliary liquid storage bodies 22, auxiliary media, and manuals and undesired substances such as waste fluid and waste toner. In this case, the mounting unit 16 may function as a second storage unit. The second storage unit is independent of the first storage unit implemented by the medium holder 17. The second storage unit stores objects related to the printing apparatus 11. Examples of such related objects include liquid, media, waste fluid, and accessories.

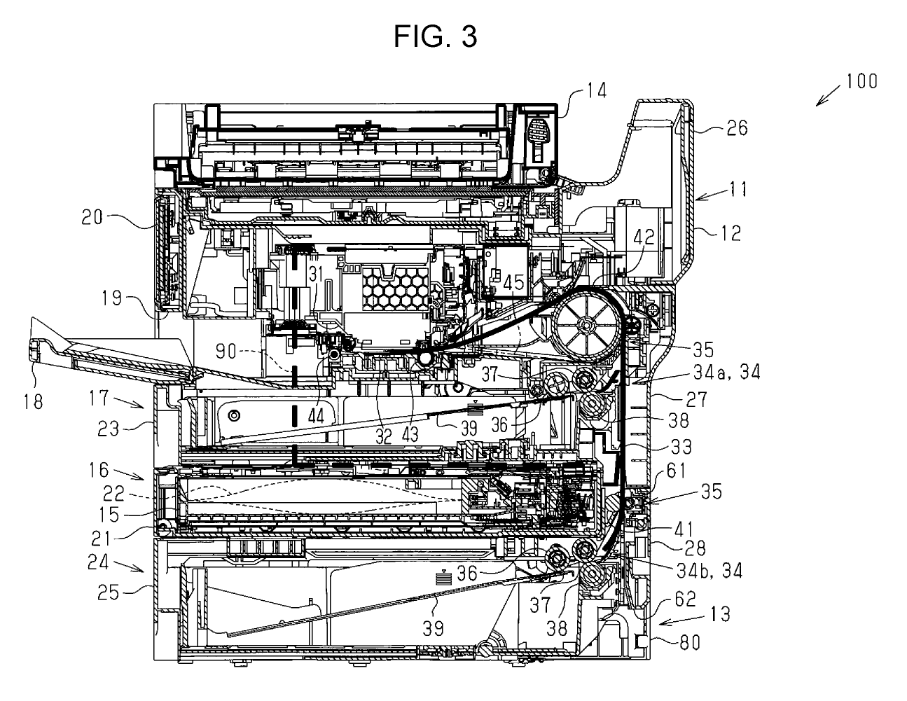

The mounting unit 16 (second storage unit 16) is preferably disposed under the medium holder 17. This configuration enables the distance between a pickup roller 36 and an intermediate roller 42, which will be described later with reference to FIG. 3, to be shorter than that of a configuration in which the mounting unit 16 is disposed over the medium holder 17, thereby successfully transporting the media S of any specified size from the medium holder 17 in the transport direction.

The extension unit 13 includes a housing 80 in which a medium storage unit (third storage unit) 24 is disposed. This medium storage unit 24 can accommodate the media S. The medium storage unit 24 disposed under the mounting unit 16 has a medium storage body 25 that can accommodate a pile of media S. The medium storage body 25 performs substantially the same function as the medium holding body 23 provided in the medium holder 17 in the apparatus main body 12, and is detachable from the front surface of the extension unit 13. In this case, the medium storage unit 24 accommodates the media S through the medium storage body 25. Alternatively, the medium storage unit 24 may accommodate the media S directly, in which case the medium storage body 25 is not necessary.

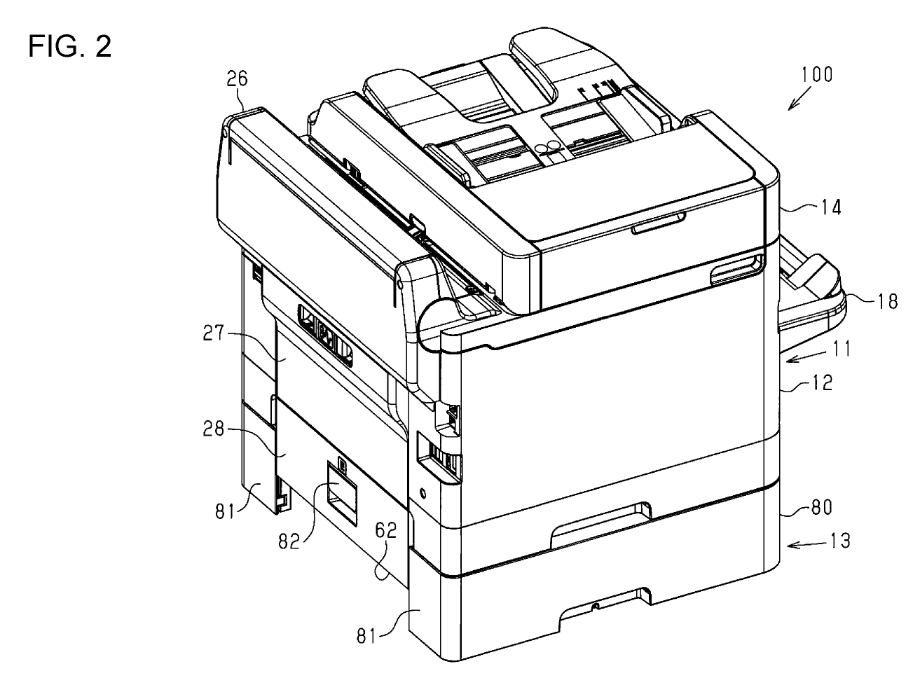

As illustrated in FIG. 2, the apparatus main body 12 has a rear automatic sheet feeder (ASF) 26 in an upper portion of the rear surface of the printing system 100. The rear automatic sheet feeder 26 projects backward and upward. A plurality of media S to be transported to the apparatus main body 12 can be placed on the rear ASF 26. When a medium S is placed on the rear ASF 26, the medium S is transported to the interior of the apparatus main body 12 and information is printed thereon, after which the media S is ejected to the ejection tray 18. The apparatus main body 12 has a cover 27 under the rear ASF 26. This cover 27 is detachably attached to the apparatus main body 12. When the cover 27 is attached to the apparatus main body 12, the surface of the cover 27 forms a portion of the rear surface of the apparatus main body 12. More specifically, the surface of the cover 27 forms substantially the central portion of the rear surface of the apparatus main body 12 in the width direction.

The extension unit 13 added to the apparatus main body 12 has a protective wall 28 on its rear surface. The protective wall 28 is disposed adjacent to the cover 27 of the apparatus main body 12. The protective wall 28 is a member that forms a portion of the housing 80 and protects a mechanism inside the extension unit 13. The protective wall 28 has substantially the same width as the cover 27 of the apparatus main body 12. The surface of the protective wall 28 forms a portion of the rear surface of the extension unit 13. More specifically, the surface of the protective wall 28 forms the central portion of the rear surface of the extension unit 13 in the width direction. In this case, the rear surface of the extension unit 13 which contains the surface of the protective wall 28 is flush with the rear surface of the apparatus main body 12 which contains the surface of the cover 27.

The protective wall 28 of the extension unit 13 is provided so as to be shifted slightly upward from rear walls 81. The rear walls 81 are portions of the outer wall forming the rear surface of the extension unit 13 and positioned on both sides of the protective wall 28 in the width direction. When the extension unit 13 is added to the apparatus main body 12, the protective wall 28 vertically overlaps the rear surface of the apparatus main body 12. To ensure this overlapping, the cover 27 of the apparatus main body 12 has a slightly lower height than that of each rear wall 81, which is a portion of the outer wall forming the rear surface of the apparatus main body 12 and positioned on both sides of the cover 27 in the width direction.

As illustrated in FIG. 3, the apparatus main body 12 is provided with the mounting unit (second storage unit) 16 between the medium holder (first storage unit) 17 and the medium storage unit (third storage unit) 24. The apparatus main body 12 includes a printing unit 31 and a medium support unit 32 above the medium holder 17. The printing unit 31 is connected to the liquid storage bodies 22 in the mounting unit 16 through a liquid supply route 90 in the mounting unit 16. This printing unit 31 discharges the liquids (recording materials) supplied from the liquid storage bodies 22 onto a medium S, thereby printing information on the medium S. In short, the mounting unit 16 is provided with the liquid supply route 90 through which the liquids contained in the liquid storage bodies 22 are supplied to the printing unit 31. The liquid supply route 90 extends above the mounting unit 16. More specifically, the liquid supply route 90 extends from the rear of the mounting unit 16 to the front thereof. The liquid supply route 90 extends in this manner is curved upward and connected to the front of the printing unit 31. The medium support unit 32 is disposed opposite the printing unit 31 and supports a medium S from its lower side while the printing unit 31 is performing the print operation.

The printing apparatus 11 includes a transport route 33, a paper feed mechanism 34, and a transport unit 35. The transport route 33 extends from the medium storage unit 24 in the extension unit 13 to the printing unit 31 in the apparatus main body 12. The paper feed mechanism 34 feeds the media S accommodated in the printing apparatus 11 to the transport route 33. The transport unit 35 transports the media S along the transport route 33 which have been fed by the paper feed mechanism 34. Thus, the transport route 33 is provided across the apparatus main body 12 and the extension unit 13. In short, the printing system 100 is provided with the transport route 33 along which the media S are transported from the extension unit 13 to the printing unit 31 in the printing apparatus 11.

In the printing apparatus 11, the mounting unit 16 is disposed between the printing unit 31 and the medium storage unit 24. Therefore, the transport route 33 extends behind the mounting unit 16 from the medium storage unit 24 to the printing unit 31, namely, extends so as to avoid the mounting unit 16. More specifically, the transport route 33 extends upward from the rear of the medium storage unit 24 in the extension unit 13 and passes behind both the mounting unit 16 and the medium holder 17 in the apparatus main body 12. The transport route 33 that extends in this manner is curved toward the front of the printing apparatus 11 and reaches the space between the printing unit 31 and the medium support unit 32.

A paper feed mechanism 34 is disposed in the extension unit 13, similar to the paper feed mechanism 34 in the apparatus main body 12. The paper feed mechanism 34 disposed in the apparatus main body 12 feeds the media S accommodated in the medium holder 17 to the transport route 33. Likewise, the paper feed mechanism 34 disposed in the extension unit 13 feeds the media S accommodated in the medium storage unit 24 to the transport route 33. The paper feed mechanism 34 disposed in the apparatus main body 12 corresponds to a first paper feed mechanism 34a in the printing apparatus 11. The paper feed mechanism 34 disposed in the extension unit 13 corresponds to a second paper feed mechanism 34b in the extension unit 13. The paper feed mechanisms 34 disposed in the apparatus main body 12 and the extension unit 13 have substantially the same configuration. Therefore, the first paper feed mechanism 34a and the paper feed mechanism 34b are not differentiated from each other, and only the paper feed mechanism 34 in the extension unit 13 will be described below.

The paper feed mechanism 34 disposed in the extension unit 13 includes: the pickup roller 36 by which the media S are taken out from the medium storage unit 24; and a separation roller 37 and a retard roller 38 by which the media S taken out by the pickup roller 36 are separated from one another. The separation roller 37 and the retard roller 38 are disposed behind the pickup roller 36 and face each other with a medium S therebetween. The pickup roller 36 and the separation roller 37 make contact with the same surface of a medium S, but the retard roller 38 makes contact with the opposite surfaces of the medium S. The retard roller 38 rotates in accordance with the rotation of the separation roller 37. In this case, the coefficient of friction between the retard roller 38 and a medium S is greater than that between the separation roller 37 and the medium S. Due to this difference in coefficient of friction, the separation roller 37 and the retard roller 38 separate the media S from one another.

The medium storage body 25 in the medium storage unit 24 has a hopper 39 that upwardly pushes the media S accommodated therein. The rear end of this hopper 39 is lifted up by an elastic member, such as a spring, so that the front end acts as a fulcrum point and the rear end is positioned higher than the front end. As a result, the media S is accommodated in the medium storage unit 24 with its rear ends lifted up and pressed against the pickup roller 36 by the hopper 39. Alternatively, the rear end of the hopper 39 may be lifted up by a driving power transfer mechanism, such as a motor, so that the front end acts as a fulcrum point and the rear end is positioned higher than the front end.

The media S lifted up in the above manner are fed toward the upstream end of the transport route 33 by the paper feed mechanism 34 in the extension unit 13. The medium holding body 23 in the medium holder 17 also has another hopper 39. The media S lifted up by this hopper 39 in the medium holder 17 are fed toward a midway point of the transport route 33 by the paper feed mechanism 34 in the apparatus main body 12. This paper feed mechanism 34 is disposed so as to overlap the mounting unit 16 in a direction substantially perpendicular to the floor on which the printing apparatus 11 is installed, or in a vertical direction in this embodiment. In addition, the liquid supply route 90 extending from the rear of the mounting unit 16 is disposed so as to overlap the paper feed mechanism 34 in the vertical direction. In this embodiment, the paper feed mechanisms 34a and 34b are positioned so as to vertically overlap each other behind the mounting unit 16.

The extension unit 13 is provided with a transport unit 35, similar to the printing apparatus 11. These transport units 35 include a plurality of transport members, such as rollers, that are arranged along the transport route 33. In this embodiment, feed rollers 41, the intermediate roller (inversion roller) 42, and a transport roller 43 are arranged along the transport route 33 in this order from the upstream side. Further, the feed rollers 41 are provided in the extension unit 13, and the intermediate roller 42 and the transport roller 43 are provided in the apparatus main body 12. In this embodiment, the respective transport units 35 are provided across the apparatus main body 12 and the extension unit 13. The feed rollers 41 constitute the transport unit 35 in the extension unit 13. The intermediate roller 42 and the transport roller 43 constitute the transport unit 35 in the apparatus main body 12.

The feed rollers 41 are provided in the transport route 33 at upstream locations and behind the mounting unit 16. In short, the feed rollers 41 are disposed so as to overlap the mounting unit (second storage unit) 16, which is a component of the printing apparatus 11, in the direction substantially horizontal to the installed floor of the printing apparatus 11. The feed rollers 41 transport the media S upward along the transport route 33 which has been fed by the paper feed mechanism 34. Thus, the feed rollers 41 fulfill their function only when supplied with the media S from the medium storage unit 24 in the extension unit 13. The intermediate roller 42 is disposed in the transport route 33 at a midway point. The intermediate roller 42 is disposed in the transport route 33 at a downstream location in the transport direction of the media S. The intermediate roller 42 that is disposed downstream of the pickup roller 36 constituting the paper feed mechanism 34 in the printing apparatus 11 transports the media S forward along the transport route 33 which has been transported by the feed roller 41. In some cases, the intermediate roller 42 also transports the media S forward along the transport route 33 which has been placed on the rear ASF 26. The transport roller 43 is provided in the transport route 33 at a downstream location and adjacent to the medium support unit 32. The transport roller 43 transports the media S forward along the transport route 33 which has been transported by the intermediate roller 42.

When receiving a medium S fed from the medium storage unit (third storage unit) 24 or the medium holder (first storage unit) 17 by the pickup roller 36, the transport unit 35 in the printing apparatus 11 transports this medium S to the medium support unit 32 disposed in the transport route 33 on a downstream side. In this case, the medium S is taken out rearward from the medium storage unit 24 or the medium holder 17 and then transported forward to the medium support unit 32 while being turned around. As a result, an orientation of the media S positioned in the medium storage unit 24 or the medium holder 17 is the reverse of that in medium support unit 32. In short, the transport unit 35 transports the media S in the depth direction of the printing apparatus 11. The width of the media S conforms to that of the printing apparatus 11. The printing unit 31 prints information on the media S, which then is ejected to the ejection tray 18 by the ejection unit 44 disposed in front of the printing unit 31 in the apparatus main body 12.

The transport roller 43 is rotatable in both forward and reverse directions. When information is printed on both sides of a medium S, first the information is printed on one side of the medium S and then the medium S is transported by the transport roller 43 in the reverse direction. As a result, the medium S is transported to a double-sided print route 45, which is independent of the transport route 33. The double-sided print route 45 extends in the apparatus main body 12 from the transport roller 43 to the intermediate roller 42. Then, after transported to the double-sided print route 45, the medium S is returned to the transport route 33 and transported to the printing unit 31 again while turned around. In this case, the intermediate roller 42 also functions as an inversion roller that turns around the medium S.

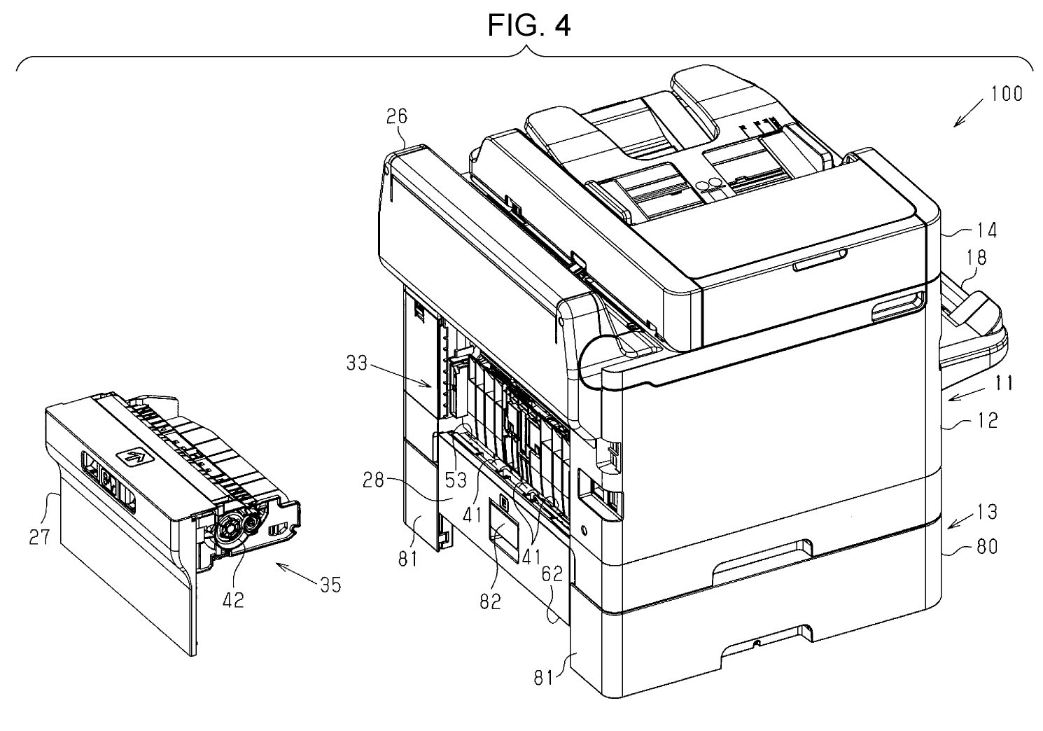

As illustrated in FIG. 4, the intermediate roller 42 that constitutes the transport unit 35 is mounted on the cover 27 that constitutes a portion of the rear surface of the apparatus main body 12. When the cover 27 is removed from the apparatus main body 12, the intermediate roller 42 is separated from the apparatus main body 12, and the transport route 33 is partly exposed. Even if a medium S is jammed in the transport route 33, a user can manually remove the cover 27 from the apparatus main body 12 and eliminate the jammed medium S from the printing apparatus 11. The protective wall 28 is provided with a jam clearing lever 82 to be held by a user's hand. The jam clearing lever 82 is positioned at substantially the center of the protective wall 28 in the width direction. If the user pulls out the jam clearing lever 82, the protective wall 28 pivots about its lower edge as a fulcrum point. In this case, the feed roller 41 and its opposing driven roller move together with the protective wall 28. In short, when the user pulls out the jam clearing lever 82, the medium S caught between the feed roller 41 and its opposing driven roller is released therefrom. In this way, the user can eliminate the jammed medium S from the transport route 33.

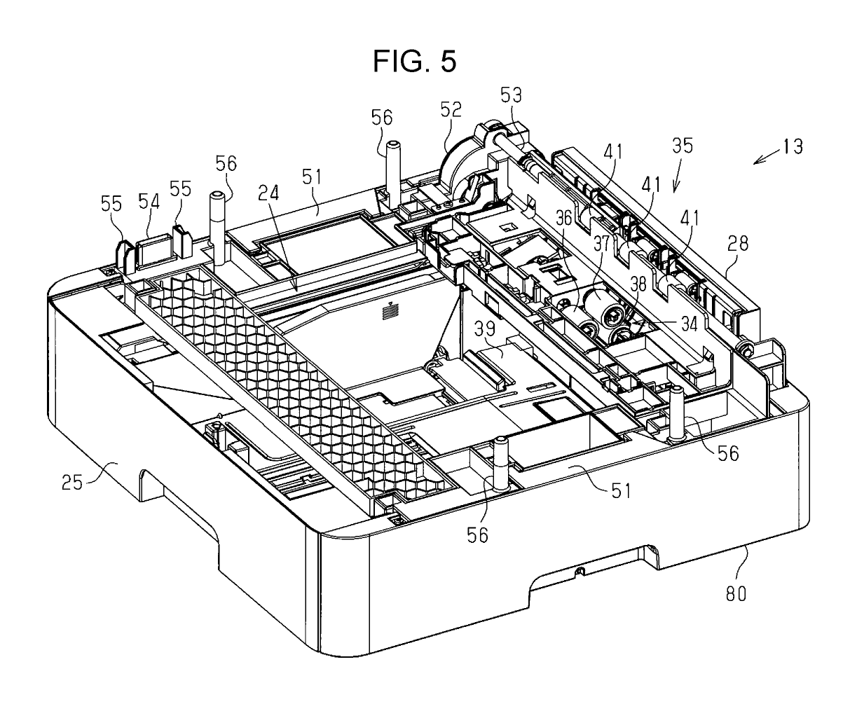

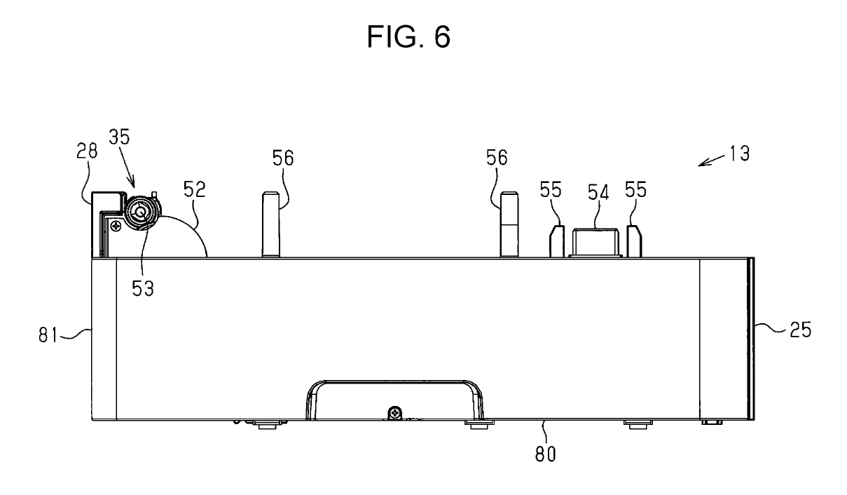

As illustrated in FIGS. 5 and 6, the extension unit 13 is provided with the medium storage unit 24 at substantially the center in the width direction. In addition, the extension unit 13 includes support units 51 on both sides in the width direction. The support units 51 support loads from the apparatus main body 12 when the extension unit 13 is added to the apparatus main body 12. The extension unit 13 has a driver 52 on one side in the width direction and near the rear. This driver 52 drives the paper feed mechanism 34 and the feed rollers 41 constituting the transport unit 35 in the extension unit 13. The driver 52 is connected to a shaft 53 that extends above the paper feed mechanism 34 in the width direction. The shaft 53 rotatably supports the feed rollers 41. The feed rollers 41 are disposed in the upper inner space of the extension unit 13 and above the rear wall 81. The protective wall 28 of the extension unit 13 extends vertically so as to be able to protect the feed rollers 41. More specifically, the protective wall 28 is erected vertically such that its upper edge is positioned higher than the feed rollers 41. In other words, the feed rollers 41 are disposed so as to protrude upward from the upper edge of an outer wall (rear wall 81) of the housing 80; this outer wall is disposed at a location different from that of an outer wall (protective wall 28) on which the feed rollers 41 are disposed.

The extension unit 13 further includes a terminal 54 on the same side as the driver 52 and near the front. The terminal 54 extends upward and supplies electricity to the driver 52 and other electrically operated members. When the extension unit 13 is attached to the apparatus main body 12, electricity is supplied from the apparatus main body 12 to the extension unit 13. In this embodiment, not only the driver 52 and the terminal 54 but also other electrically operated members are disposed on the same side in the width direction. The extension unit 13 includes protective projections 55 each of which protrudes upward, similar to the terminal 54. The protective projections 55 are provided so as to be able to protect the terminal 54 and sandwich the terminal 54 in the depth direction of the extension unit 13. To protect the terminal 54, each protective projection 55 extends upward beyond the height of the terminal 54.

The extension unit 13 has a plurality of positioning pins 56 that extend upward from the support units 51. Two of the positioning pins 56 are provided on each side of the extension unit 13 in the width direction and near the front and rear of the extension unit 13, respectively. The positioning pins 56 are members that position the extension unit 13 relative to the apparatus main body 12 when the extension unit 13 is added to the apparatus main body 12. By inserting the positioning pins 56 into the corresponding holes in the bottom of the apparatus main body 12, the extension unit 13 is positioned relative to the apparatus main body 12.

In this embodiment, each positioning pin 56 extends until its upper end becomes substantially flush with the upper edge of the protective wall 28. In this case, the upper end of each positioning pin 56 is positioned higher than those of each feed roller 41 and the terminal 54. Therefore, when the extension unit 13 is added to the apparatus main body 12, the upper end of each positioning pin 56 makes contact with the floor surface of the apparatus main body 12. This configuration can reduce the risk of the terminal 54 and the feed rollers 41 in the transport unit 35 making contact with the floor surface of the apparatus main body 12 and thus being damaged.

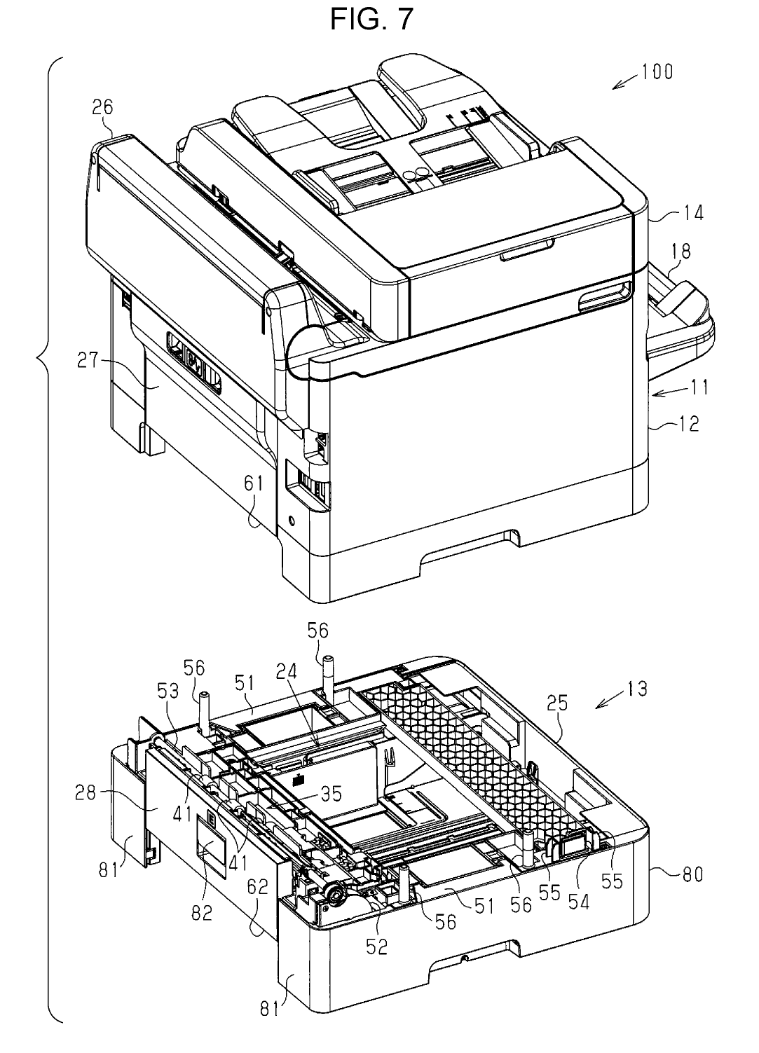

As illustrated in FIG. 7, the apparatus main body 12 includes a recess 61 in its rear surface containing the surface of the cover 27. This recess 61 is depressed toward the interior of the apparatus main body 12. The recess 61 is provided behind the mounting unit 16 in the apparatus main body 12 (see FIG. 3). When the extension unit 13 is added to the apparatus main body 12, the recess 61 is covered with the protective wall 28. Furthermore, when the extension unit 13 is added to the apparatus main body 12, the recess 61 accommodates the feed rollers 41 in the transport unit 35 in the extension unit 13. In short, the recess 61 is provided to position the transport unit 35 behind the mounting unit 16. Similar to the apparatus main body 12, the extension unit 13 includes a recess 62 in the rear surface of the housing 80 and below the protective wall 28.

The recess 62 is provided behind the medium storage unit 24 in the extension unit 13 (see FIG. 3). This recess 62 fulfils its function only when a plurality of extension units 13 are added to the apparatus main body 12. When another extension unit is further attached to the lower portion of the extension unit 13, the recess 62 in the extension unit 13 accommodates feed rollers of this extension unit and is covered with its protective wall. In other words, when a second extension unit, which is another extension unit independent of the extension unit 13, is disposed under the extension unit 13, the recess 62 in the extension unit 13 accommodates feed rollers of the second extension unit. In this case, the distance between the feed rollers 41 in the extension unit 13 and the intermediate roller 42 in the apparatus main body 12 is preferably substantially the same as the distance between the feed rollers 41 in the extension unit 13 and feed rollers in the second extension unit. In addition, it is preferable that the length of the recesses 61 and 62 in the width direction be substantially the same as that of the cover 27 and the protective wall 28 in the width direction and be greater than the width of the media S of the largest size that can be accommodated in the medium storage unit 24.

Next, a description will be given of effects of the printing system 100 and the extension unit 13 configured above.

The configuration in which the feed rollers 41 in the transport unit 35 in the extension unit 13 are disposed behind the mounting unit 16 enables the individual distances between the paper feed mechanisms 34 and the transport units 35 in the transport route 33 to be shorter than those of a configuration in which the feed rollers 41 are not disposed behind the mounting unit 16.

When the feed rollers 41 are not disposed behind the mounting unit 16, for example, the feed rollers 41 need to be disposed above or below the mounting unit 16. If the feed rollers 41 are disposed above the mounting unit 16, the distance between the feed rollers 41 and each of the separation roller 37 and the retard roller 38 in the paper feed mechanism 34 may increase. If the feed rollers 41 are disposed below the mounting unit 16, the distance between the feed rollers 41 and the intermediate roller 42 may increase. In this embodiment, however, the printing apparatus 11 is configured such that the feed rollers 41 in the transport unit 35 are disposed behind the mounting unit 16. This configuration enables the transport unit 35 to appropriately transport a medium S fed by the paper feed mechanism 34 even when the medium S accommodated in the medium storage unit 24 has a small size in the transport direction. In this embodiment, moreover, the extension unit 13 in the printing system 100 is provided with the feed rollers 41 positioned higher than the upper edges of the rear walls 81. Therefore, when the extension unit 13 is added to the lower portion of the printing apparatus 11, the feed rollers 41 are positioned near the printing apparatus 11.

The foregoing embodiment produces the following effects. (1) The feed rollers 41 in the extension unit 13 are disposed so as to overlap the mounting unit (second storage unit) 16 in the printing apparatus 11 in a horizontal direction. With this configuration, the feed rollers 41 can be disposed near the printing apparatus 11. Therefore, in the transport route 33, the printing unit 31 in the printing apparatus 11 can be disposed near the feed rollers 41 in the extension unit 13. Consequently, the printing system 100 can transport media S of any specified sizes appropriately.

(2) The liquid storage bodies 22 or the containers 15 each of which accommodates the liquid storage body 22 are attachable to the mounting unit (second storage unit) 16. Consequently, the printing system 100 allows the mounting unit (second storage unit) 16 to be used efficiently as a space in which recording materials such as liquids are stored.

(3) The liquid supply route 90 is disposed so as to overlap the second paper feed mechanism 34b in the vertical direction. Consequently, the printing system 100 can supply liquid appropriately to the printing unit 31 through the liquid supply route 90 despite its small footprint.

(4) The feed rollers 41 in the extension unit 13 are disposed so as to overlap the mounting unit (second storage unit) 16 in the printing apparatus 11 in a horizontal direction. With this configuration, the feed rollers 41 can be disposed near the printing apparatus 11. Therefore, in the transport route 33, the intermediate roller (inversion roller) 42 in the printing apparatus 11 can be disposed near the feed rollers 41 in the extension unit 13. Consequently, the printing system 100 can transport the media S of any specified sizes appropriately.

(5) The paper feed mechanism (second paper feed mechanism) 34b is provided with at least one of the pickup roller 36, the separation roller 37 and the retard roller 38. Consequently, the printing system 100 can feed the media S appropriately by using the paper feed mechanism (second paper feed mechanism) 34b.

(6) The feed rollers 41 in the extension unit 13 are disposed so as to protrude upward from the upper edge of an outer wall (rear walls 81) of the housing 80; this outer wall is disposed at a location different from that of an outer wall (protective wall 28) on which the feed rollers 41 are disposed. This configuration allows the feed rollers 41 to be disposed nearer the printing apparatus 11 than a configuration in which feed rollers 41 in an extension unit 13 are disposed so as not to protrude upward from the upper edge of an outer wall (rear walls 81) of the housing 80; this outer wall is disposed at a location different from that of an outer wall (protective wall 28) on which the feed rollers 41 are disposed. Consequently, the printing system 100 can transport the media S of any specified sizes appropriately.

(7) When a second extension, which is another extension unit independent of the extension unit 13, is added to the lower portion of the extension unit 13, feed rollers of the second extension are accommodated in the recess 62 in the extension unit 13. Consequently, the printing system 100 provides the extension unit 13 with an improved appearance.

(8) The feed rollers 41 are disposed so as to overlap the mounting unit (second storage unit) 16 in the horizontal direction. In this way, the inner space of the printing system 100 which overlaps the mounting unit (second storage unit) 16 in the horizontal direction is used efficiently. Thus, this configuration can suppress the enlargement of the printing system 100.

(9) The transport unit 35 that transports the media S along the transport route 33 is disposed behind the mounting unit 16. This configuration allows the paper feed mechanism 34 and the transport unit 35 to be disposed nearer each other in the transport route 33 along which the media S are transported than a configuration in which the transport unit 35 is not disposed behind the mounting unit 16. Consequently, the printing system 100 can transport the media S of any specified sizes appropriately.

(10) The extension unit 13 is provided with the medium storage unit 24 and the paper feed mechanism 34. Consequently, the printing system 100 can appropriately transport media of any specified sizes from the medium storage unit 24 in the extension unit 13.

(11) The feed rollers 41 are provided in the extension unit 13, and the intermediate roller 42 and the transport roller 43 are provided in the apparatus main body 12. This configuration provides the apparatus main body 12 with a simpler structure than a configuration in which all of the feed roller 41, the intermediate roller 42, and the transport roller 43 are provided in the apparatus main body 12. In addition, the respective transport units 35 are provided across the apparatus main body 12 and the extension unit 13. This configuration provides the apparatus main body 12 with a simpler structure than a configuration in which the apparatus main body 12 is provided with the transport unit 35 alone.

(12) When the extension unit 13 is added to the apparatus main body 12, the transport unit 35 in the extension unit 13 is positioned in the recess 61 in the apparatus main body 12. This configuration can suppress the enlargement of the printing apparatus 11.

(13) The extension unit 13 is provided with the recess 62 for addition of another extension unit. This configuration enables a plurality of extension units 13 to be added to the apparatus main body 12.

(14) The printing system 100 is provided with the medium holder 17 in the apparatus main body 12. Thus, this configuration accommodates many more media S in the printing apparatus 11 than a configuration in which the printing system 100 is provided with the medium storage unit 24 alone.

(15) When the extension unit 13 is added to the apparatus main body 12, the rear surface of the extension unit 13 is flush with the surface of the cover 27 in the apparatus main body 12. Since the rear surface of the extension unit 13 is flush with the surface of the cover 27 in the apparatus main body 12 when the extension unit 13 is added to the apparatus main body 12, the printing system 100 can provide the printing apparatus 11 with an improved appearance.

(16) The extension unit 13 is provided with the support units 51 on both sides in the width direction. The support units 51 support the apparatus main body 12. Therefore, when the apparatus main body 12 places a load on the apparatus main body 12, the load is distributed between the support units 51 provided on both sides of the apparatus main body 12 in the width direction. Consequently, the apparatus main body 12 is supported with stability by the extension unit 13.

The foregoing embodiment may be modified in the following manner. It should be noted that modifications described below may be combined as appropriate.

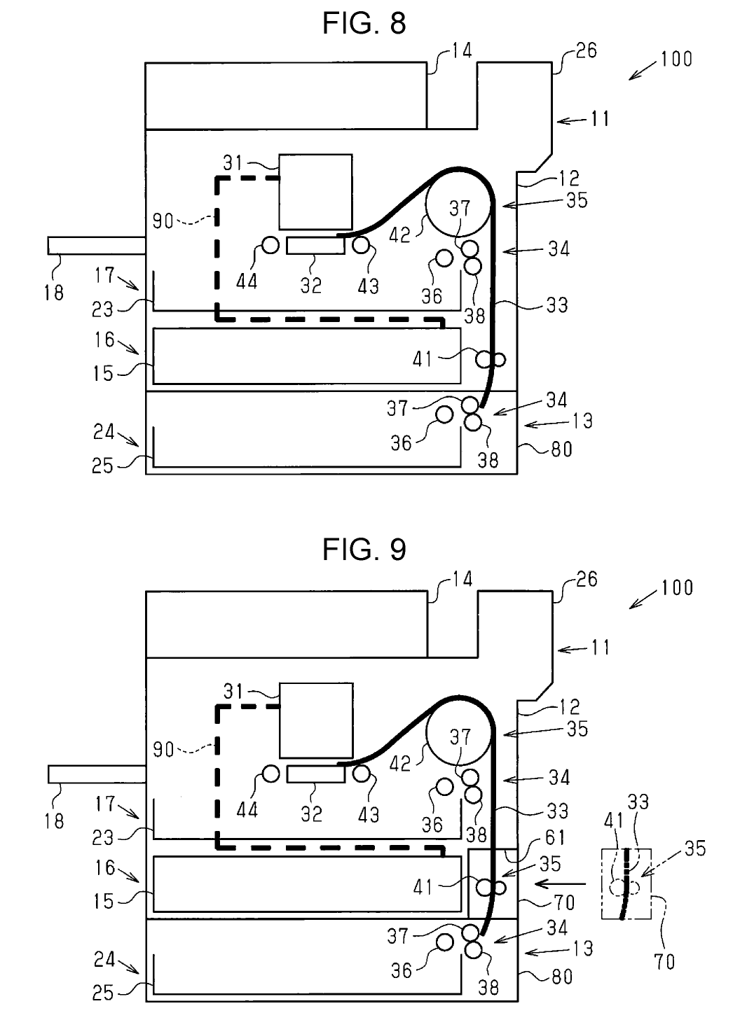

As illustrated in FIG. 8, feed rollers 41 disposed behind a mounting unit 16 may be provided in a transport unit 35 in an apparatus main body 12. In this case, the recess 61 does not have to be provided in the apparatus main body 12; the recess 62 does not have to be provided in the extension unit 13.

The above modification produces the following effect. (17) All of the feed rollers 41, an intermediate roller 42, and a transport roller 43 are provided in the apparatus main body 12. In this case, the transport unit 35 does not have to be provided in the extension unit 13. This configuration provides the extension unit 13 with a simpler structure than a configuration in which the extension unit 13 is provided with the transport unit 35. By providing the transport unit 35 in the apparatus main body 12 in this manner, the structure of the extension unit 13 can be made simple.

As illustrated in FIG. 9, feed rollers 41 in a transport unit 35 disposed behind a mounting unit 16 may be detachable from a printing apparatus 11. In short, the feed rollers 41 may be detachable from a printing system 100. For example, the printing apparatus 11 may be provided with a transport unit 70 that includes the feed rollers 41 and a portion of a transport route 33. This transport unit 70 may be detachably fitted into a recess 61 behind the mounting unit 16. In this case, an extension unit 13 to be added to an apparatus main body 12 preferably has other feed rollers behind a medium storage unit 24. Alternatively, the transport unit 70 may be detachably attached to the extension unit 13 or to both the apparatus main body 12 and the extension unit 13.

The above modification produces the following effect. (18) The feed rollers 41 can be easy to replace with others.

(19) The transport unit 70 provided with the transport unit 35 and the portion of the transport route 33 is detachably attached to one or both of the apparatus main body 12 and the extension unit 13. Therefore, the transport unit 35 can be replaced with another by the attaching/detecting of the transport unit 70.

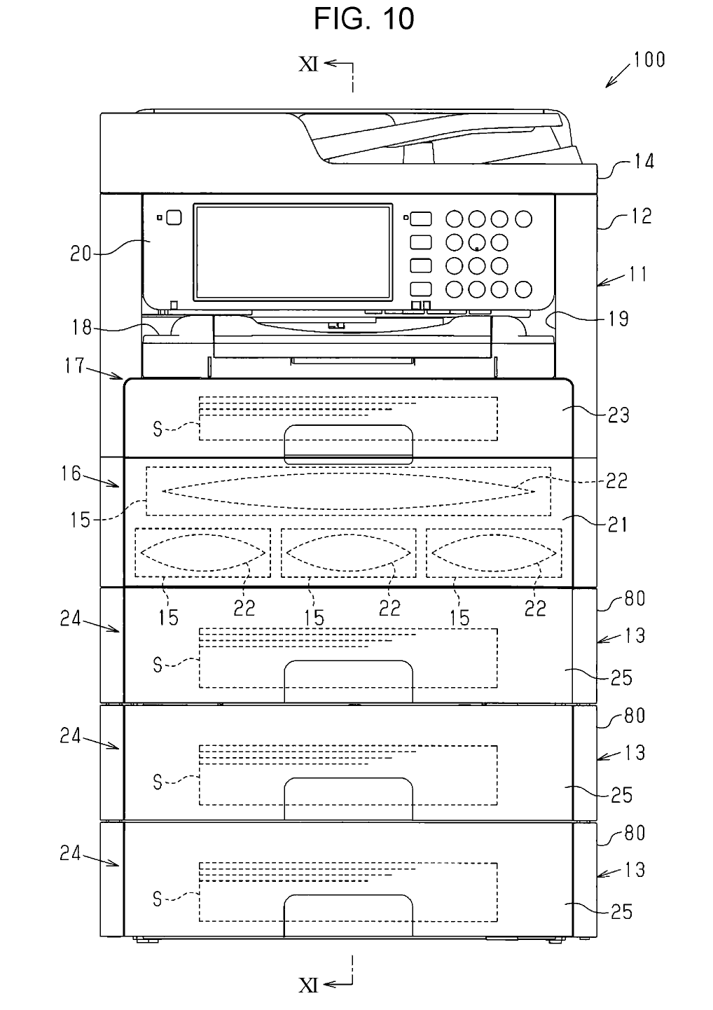

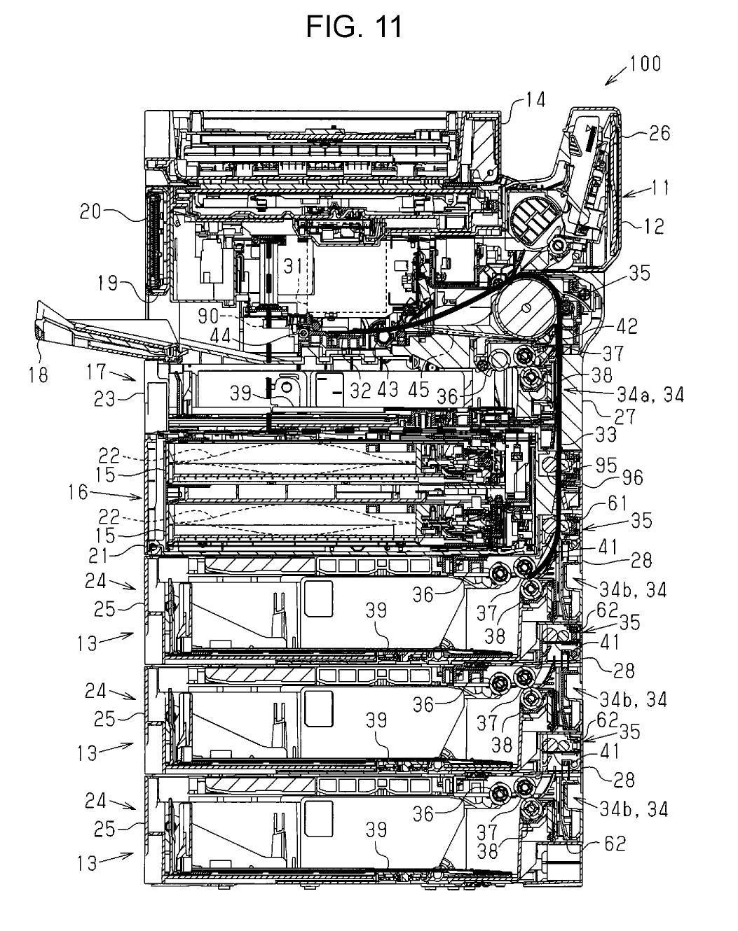

A mounting unit (second storage unit) 16 may be attached to an apparatus main body 12 with a plurality of liquid storage bodies 22 stacked therein. This modification will be described with reference to FIGS. 10 and 11. As illustrated in FIG. 10 or 11, three extension units 13 may be added to a printing apparatus 11.

FIG. 10 illustrates a printing system 100 in a modification. As illustrated in FIG. 10, the mounting unit 16 accommodates the liquid storage bodies 22 stacked in two stages. In this modification, a liquid storage body 22 containing a black ink is disposed in the upper stage of the mounting unit 16, and three liquid storage bodies 22 containing color inks, such as cyan, magenta, and yellow inks, respectively, are disposed in the lower stage thereof. The liquid storage body 22 containing the black ink has a larger capacity than that of any other liquid storage body 22. Thus, the liquid storage body 22 containing the black ink has the largest size in a width direction among the liquid storage bodies 22 in the width direction of the media S.

A black ink is used many times, because it is used for a monochrome print operation. Therefore, by using a large capacity of liquid storage body as the liquid storage body 22 containing the black ink, a monochrome print operation can be continuously performed. This can contribute to improved usability. Alternatively, the liquid storage bodies 22 containing color inks, such as cyan, magenta, and yellow inks, may be disposed in the upper stage in the mounting unit 16. The liquid storage body 22 containing the black ink may be disposed in the lower stage in the mounting unit 16. In this way, the arrangement of the liquid storage bodies 22 in the mounting unit 16 may be modified as appropriate.

The above configuration in which the plurality of liquid storage bodies 22 are stacked in the mounting unit 16 enables a large total amount of inks to be contained in the liquid storage bodies 22. However, this configuration may cause the mounting unit 16 to be enlarged vertically, in which case a transport route 33 formed behind the mounting unit 16 may also be prolonged vertically. As a result, in the transport route 33, an intermediate roller 42 in the printing apparatus 11 may be disposed away from feed rollers 41 in the extension unit 13.

FIG. 11 illustrates a printing system 100 in another modification. The printing apparatus 11 is provided with, in addition to feed rollers 41 in extension units 13, feed rollers 95 disposed in a transport route 33 and upstream of an intermediate roller 42. For the sake of convenience in the following description, the feed rollers 41 in the extension units 13 are referred to below as the “first feed rollers 41”, whereas the feed rollers 95 in the printing apparatus 11 is referred to below as the “second feed rollers 95”. In this modification, the second feed rollers 95, the first feed rollers 41, and the intermediate roller 42 constitute transport units 35. The second feed rollers 95 are components of the transport unit 35 in the apparatus main body 12. The second feed rollers 95 are disposed in the transport route 33 between the first feed rollers 41 and the intermediate roller 42.

The second feed rollers 95 are disposed behind a mounting unit 16. In other words, the second feed rollers 95 are disposed so as to overlap the mounting unit 16 in a horizontal direction. In this modification, the second feed rollers 95 are disposed behind the liquid storage body 22 in the upper stage in the mounting unit 16. The first feed rollers 41 are disposed behind the liquid storage body 22 in the lower stage in the mounting unit 16.

The second feed rollers 95 transport media S to the intermediate roller 42 which has been fed by the first feed rollers 41. In this configuration, the rollers constituting the transport units 35 are arranged along the transport route 33 at short intervals. Thus, the printing system 100 can transport the media S of any specified sizes appropriately.

The second feed rollers 95 are covered with a cover 96, which is another cover independent of the cover 27 disposed behind the apparatus main body 12. Similar to the cover 27, the cover 96 forms a portion of the rear surface of the apparatus main body 12 and is detachably attached to the apparatus main body 12. The cover 96 is disposed below the cover 27. The cover 96 supports a driven roller disposed so as to pair up with the second feed rollers 95. Therefore, when the cover 96 is detached from the apparatus main body 12, the driven roller is also detached therefrom. By detaching the cover 96 from the apparatus main body 12, the transport route 33 becomes partly exposed. As a result, a user can eliminate the medium S when a medium S is jammed in the transport route 33. Alternatively, the cover 96 may be fixed to the apparatus main body 12. In this case, when a medium S is jammed in the transport route 33, the user can detach the cover 27 from the apparatus main body 12 and eliminate the medium S from the transport route 33.

The second feed roller 95 is connected to the first feed roller 41 in the extension unit 13 through an unillustrated wheelwork. Therefore, driving power is transmitted from the first feed roller 41 to the second feed roller 95. As a result, the second feed roller 95 rotates in accordance with the rotation of the first feed roller 41. Thus, the second feed roller 95 can rotate only when the extension unit 13 is added to the printing apparatus 11.

The second feed roller 95 fulfils its function only when the media S are transported from an extension unit 13 to the printing apparatus 11. This configuration can use the driving power efficiently. This is because the second feed roller 95 does not rotate in the case where the media S are not transported from a medium storage unit 24 in the extension unit 13 to a printing apparatus 11. This case may occur, for example when the printing apparatus 11 operates alone with no extension units 13 added thereto or when the media S are transported from a medium holder 17 in the printing apparatus 11. In addition, the configuration in which the first feed rollers 41 and the second feed rollers 95 rotate together does not involve any complicated control. One example of such complicated control is to stop rotating the second feed rollers 95 when the media S are transported from the medium holder 17 and in turn rotate the second feed rollers 95 when the media S are transported from the medium storage unit 24. In short, this configuration controls the second feed roller 95 more easily than a configuration in which an apparatus main body 12 directly transmits the driving power to the second feed roller 95.

The transport unit 35 is provided with three types of transport members including the feed rollers 41, the intermediate roller 42, and a transport roller 43. However, there is no limitation on a configuration of the transport unit 35. Alternatively, the transport unit 35 may include any number of types of transport members. In the transport unit 35, at least one transport member may be disposed behind the mounting unit 16. It is more preferable for the printing apparatus 11 to have a smaller number of transport members, in terms of its overall cost.

Each paper feed mechanism 34 includes three members including the pickup roller 36, the separation roller 37, and the retard roller 38. However, there is no limitation on a configuration of each paper feed mechanism 34. Alternatively, each paper feed mechanism 34 may include any number of types of members.

Each paper feed mechanism 34 only has to include at least one of the pickup roller 36, the separation roller 37, and the retard roller 38.

A medium S on which information is to be printed by the printing apparatus 11 is not limited to a paper sheet. As an alternative example, a medium S may be a cloth or plastic sheet. In short, the media S to be accommodated in the medium holder 17 and the medium storage unit 24 do not necessarily have to be paper sheets.

The printing apparatus 11 does not necessarily have to be provided with the medium holder 17. As an alternative example, the media S may be transported only from the medium storage unit 24.

Each extension unit 13 may be integrated with the apparatus main body 12. In this case, the apparatus main body 12 may be provided with the medium storage units 24.

The pickup roller 36 may be movable toward or away from the media S accommodated in the medium storage unit 24 (medium holder 17). In this case, the medium storage unit 24 (medium holder 17) does not have to be provided with the hopper 39.

The printing apparatus 11 provided in the printing system 100 may be implemented by a fluid ejection apparatus that performs a print operation by discharging fluid other than ink. Examples of such fluid include liquid, a liquid body, and a fluid body. For example, a liquid body may be formed by dispersing or mixing particles of a functional material in a liquid; a fluid body may be in the gel form. As a specific example, the printing apparatus 11 may be implemented by a liquid body ejection apparatus that performs a print operation by discharging a liquid body that contains, in the form of a dispersion liquid or solution, a material, such as an electrode material or a color material (pixel material), that is mainly used to manufacture liquid crystal displays, electroluminescent (EL) displays, or surface emitting displays. As another specific example, the printing apparatus 11 may be implemented by a fluid body ejection apparatus that discharges a fluid body, such as a gel or a physical gel. The foregoing embodiment and modifications may be applied to the above apparatuses. The word “fluid” discussed herein refers to any type of fluid except fluid in a gaseous form. Examples of such fluid include liquid, a liquid body, and a fluid body; examples of such liquid include an inorganic solvent, an organic solvent, a solution, a liquid resin, a liquid metal, and a metallic melt.

The entire disclosures of Japanese Patent Applications No. 2016-254249, filed on Dec. 27, 2016 and No. 2017-188287, filed on Sep. 28, 2017 are expressly incorporated by reference herein.

What is claimed is:

1. A printing system comprising:
a printing apparatus;
an extension unit that accommodates media, the extension unit being disposed below the printing apparatus; and
a transport route along which the media are transported to a printing unit in the printing apparatus,
the printing apparatus including:
the printing unit that prints information on the media by using a recording material;
a first storage unit that accommodates the media;
a second storage unit that accommodates an object related to the printing apparatus, the second storage unit being disposed below the first storage unit; and
a first paper feed mechanism that feeds the media accommodated in the first storage unit to the transport route,
the extension unit including:
a housing;
a third storage unit that accommodates the media;
a second paper feed mechanism that feeds the media accommodated in the third storage unit to the transport route; and
a feed roller that transports the media fed by the second paper feed mechanism, the feed roller being disposed in the transport route,
the feed roller being disposed so as to overlap the second storage unit in a horizontal direction.

2. The printing system according to claim 1, wherein
a liquid storage body that contains a liquid as the recording material or a container that accommodates the liquid storage body is attachable to the second storage unit.

3. The printing system according to claim 2, wherein
the second storage unit includes a liquid supply route along which the liquid contained in the liquid storage body is supplied to the printing unit, and
the liquid supply route is provided so as to overlap the second paper feed mechanism in a vertical direction.

4. The printing system according to claim 1, wherein
the second paper feed mechanism includes at least one of a pickup roller, a retard roller, and a separation roller that feeds one by one the media in the extension unit.

5. A printing system comprising:
a printing apparatus;
an extension unit that accommodates media, the extension unit being disposed below the printing apparatus;
a transport route along which the media are transported to a printing unit in the printing apparatus; and
a feed roller disposed in the transport route,
the printing apparatus including:
the printing unit that prints information on the media by using a recording material;
a first storage unit that accommodates the media;
a first paper feed mechanism that feeds the media accommodated in the first storage unit to the transport route;
an inversion roller disposed in the transport route and downstream of the first paper feed mechanism in a transport direction of the media; and
a second storage unit disposed below the first storage unit, a liquid storage body that contains a liquid as the recording material or a container that accommodates the liquid storage body being attachable to the second storage unit,
the extension unit including:
a third storage unit that accommodates the media, the third storage being disposed below the second storage unit, and
a second paper feed mechanism that feeds the media accommodated in the third storage unit to the transport route,
the feed roller being disposed so as to overlap the second storage unit in a horizontal direction, the feed roller transporting the media fed by the second paper feed mechanism to the inversion roller.

6. The printing system according to claim 5, wherein
the second storage unit includes a liquid supply route along which the liquid contained in the liquid storage body is supplied to the printing unit, and
the liquid supply route is provided so as to overlap the second paper feed mechanism in a vertical direction.

7. The printing system according to claim 6, wherein
the feed roller is detachable from the printing system.

8. The printing system according to claim 5, wherein
the second paper feed mechanism includes at least one of a pickup roller, a retard roller, and a separation roller that feeds one by one the media in the extension unit.

9. An extension unit to be added to a printing apparatus, comprising:
a housing;
a medium storage unit that accommodates media;
a paper feed mechanism that feeds the media accommodated in the medium storage unit; and
a feed roller that transports the media fed by the paper feed mechanism to the printing apparatus,
the feed roller being disposed so as to overlap the printing apparatus in a horizontal direction when the extension unit is attached to a lower portion of the printing apparatus.

10. The extension unit according to claim 9, wherein
the housing has a recess in its rear surface, and
when a second extension unit is further disposed below the extension unit, the recess accommodates a feed roller of the second extension unit.
